(19) United States
(12) Patent Application Publication
(10) Pub. No.: US 2016/0259523 A1
(43) Pub. Date: Sep. 8, 2016

(54) Web Comments with Animation

(71) Applicant: Greg Watkins, Littleton, CO (US)

(72) Inventor: Greg Watkins, Littleton, CO (US)

(21) Appl. No.: 14/641,288

(22) Filed: Mar. 6, 2015

(51) Int. Cl. G06F 3/0481; G06F 17/22; G06T 13/80; G06F 3/0484; G06F 3/0488

(52) U.S. Cl. CPC G06F 3/04812; G06F 3/04847; G06F 3/04842; G06F 3/04883; G06T 13/80; G06F 17/2247; G06T 2200/24

(57) ABSTRACT

The subject matter disclosed herein provides a system, method, and computer program product for organizing and animating comments on webpages made in response to articles and comments made by other readers. Animation of card groups having comment cards, which may be arranged horizontally or vertically adjacent to one another, or arranged as a digital decks of cards, or cascading panels, reduces confusion to readers and prevents readers from posting comments to incorrect locations.

### CROSS-REFERENCE TO RELATED APPLICATIONS

This application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

U.S. Provisional Patent Application App. No. U.S. 61/948,797 titled “Web Comments With Animation,” filed on Mar. 6, 2014, the subject matter of which is incorporated by reference herein in its entirety.

### STATEMENT REGARDING FEDERALLY SPONSORED RESEARCH AND DEVELOPMENT

Not Applicable.

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### BACKGROUND OF DISCLOSURE

1. Field of Invention

The present invention relates to internet comment systems and methods, and more particularly to improvements in the organization and structure of comment interfaces on telecommunication devices such as desktop computers, laptop computers, smart phones or tablet computers.

2. Description of Prior Art

Internet publishing platforms and communication systems utilize comment systems that often give readers the capability to submit comments to online media articles, such as webpage magazines, newspapers, and forums. Similar commenting systems are used on social media sites, online forums, bulletin boards, and micro-blogging sites like Facebook, Twitter, 4chan, Reddit, and Tumblr. Such comments typically offer feedback or opinion on either the article or a comment from another reader and are typically published below the article. When a comment is directed at a previously published comment, for clarification it may be displayed below that comment and indented. Comments in this way can be presented in a hierarchy, with all comments responding to a previous comment shown under it and indented.

However, the comment displays on many internet platforms that use this approach are often confusing. Some readers expect to see comments displayed in the order of the time they were published, either oldest-to-newest or newest-to-oldest, and this cannot be performed while also showing all child comments together under their common parent.

Additional confusion ensues when a comment in response to a parent comment is lengthy; a reader is more prone to respond to the child comment while thinking that he or she is responding to the parent comment or article. Some sites use a collapsible or expandable hierarchy in order to help clarify the relationship between parent comments and child comments.

U.S. Pat. No. 8,615,777, to Nishizawa et al., discloses a method and apparatus for displaying posting site comments with program being viewed. The '777 patent addresses issues related to receiving comments from multiple broadcasters, selecting which comments to publish, and grouping of comments; however, it does not address the issue of displaying comments and sub-comments in a manner that does not confuse readers, nor does it seek to improve how a comment hierarchy is to be visually organized and displayed on a screen.

U.S. Pat. 8,291,014, to Cierniak et al., discloses a reader interface for web comments wherein one or more server devices generate a document that displays content of a comment associated with a link that can be sent to a second user. The '014 patent facilitates real-time discussion over collaboration on a document or file being edited by multiple individuals simultaneously wherein the participants can confer together about proposed changes to the document or file. While the invention helps a user more efficiently share web comments during collaborative efforts, it does not facilitate ease of understanding a complex network of comments based on parent/child hierarchies and how to deliver the information to a user that is not overwhelming or confusing. The present invention instead uses different animations and a plurality of card groups that are grouped within a region in order to deliver comments to posted articles or topic discussions that would normally be organized in a discussion thread style format.

Although many internet platforms are still developing new ways to solve the issues presented in comment structures and organizations, there lacks a system that provides an efficient method to view and browse through comments without undesirable misplacement of reader comments.

### SUMMARY OF THE DISCLOSURE

The present invention provides a system, method and computer program product for reducing confusion and improving efficiency when viewing comment structures of internet platforms and telecommunication devices. Through the use of strategically organized and animated card groups, a reader can browse through a conversation of child comments and easily know which parent comment it is responding to, thus improving the reader's ability to understand the specific topic and context of each comment.

In a primary embodiment, the webpage displays a comments panel comprising a card group in a first region of the comments panel, wherein the card group comprises one or more comment cards each comprising a comment in response to an article or another comment. A reader may shuffle between comment cards in the first region by pressing a shuffle button, which initiates animation of the comment cards in the first region to present a different comment card that the reader desires to view, or the reader may shuffle between comment cards by directly pressing the comment card of his or her choosing. Card groups may be arranged in horizontal adjacently placed form, vertical adjacently placed form, or cascaded form.

Pressing of a drill link in a comment card initiates animation of the comment card from the first region to a second region of the comments panel, replaces the drill link with an undrill link, and initiates animation of child cards each comprising a child comment that responds to the parent comment located on the comment card of the second region, which becomes defined as the parent card of the child cards. Pressing of the undrill link initiates animation in reverse to the animation initiated by pressing of the drill link, thus reverting the comments panel to its initial configuration.

In an embodiment, a reader may also submit a comment in response to an article by pressing an article respond button, wherein a blank comment card having a textbox input becomes visible to the reader and allows the reader to submit a comment.

In an embodiment, a reader may also submit a comment in response to another comment by pressing a comment respond link, which acts similarly to pressing of a drill link with the exception that a blank comment card having a textbox input becomes visible to the reader and allows the reader to submit a comment.

In an embodiment, the card group is arranged in cascaded form, similar to a deck of cards, wherein the comment on the front card is visible to the reader, and other comment cards in the card group are only partially visible to the reader.

In an embodiment, the card group is arranged in a horizontal adjacently placed form with a first region appearing to the right or left of a second region and with comment cards not overlapping.

In an embodiment, the card group is arranged in a vertically adjacently placed form with a first region appearing to the top or bottom of a second region and with comment cards not overlapping.

In embodiments described herein, the term “pressing” may refer to the clicking, pressing, or actuating of a button or link. The terms “link” and “button” are used interchangeably, and any of the links, or buttons, discussed herein may be in the form of text, icons, graphics or other forms.

In embodiments described herein, the term “non-viewable” location may refer to any location out of view and generally refers to a side and out of view or into a background and out of view.

A reader can also browse easily through comments within the same level of a comment hierarchy without having to use a scrollbar to view various comments related to the discussion. The scrollbar requires a certain level of arm movement accuracy for adjusting the screen window to display a particular location in the comment hierarchy. This method allows only a vertical browsing dimension, so child comments are typically indented if they are to be identified. When a reader stops scrolling, it is possible that a particular comment may only be partially visible.

By allowing two dimensions of browsing (horizontally to stay within one conversation, and vertically to drill into a child conversation) and by using buttons with animated cards, the above scrollbar problems are eliminated.

The system, method, and computer program product described herein clarify to the reader which comment is a parent comment or a child comment and where the appropriate location for the reader's response to be entered, thus enhancing reader experience and reducing confusion, stress and the spread of misinformation. They also clarify that comments being shuffled in the deck are all at the same level within the comment hierarchy.

Embodiments include one, more, or any combination of all of the features listed above.

Other features and advantages of the present invention will become apparent from the following more detailed description, taken in conjunction with the accompanying, which illustrate, by way of example, the principles of the invention.

### DESCRIPTION OF THE DRAWINGS

FIG. 1 is a diagram of an example video display interface showing an article and a comments panel on a webpage, in accordance with an exemplary embodiment of the present invention;

FIG. 2a and FIG. 2b are diagrams of a comments panel with a first region appearing below a second region and with a card group comprising comment cards arranged in cascaded form, wherein one of two shuffle buttons have been pressed to initiate animation of the comment cards, wherein FIG. 2a shows the comment cards in an initial configuration and FIG. 2b shows the comment cards in a shuffled configuration, in accordance with an exemplary embodiment of the present invention;

FIG. 3a, FIG. 3b, and FIG. 3c are diagrams of an exemplary embodiment of the invention wherein a user comment can be created, featuring a comments panel with a first region appearing below a second region and with a card group comprising comment cards arranged in cascaded form, wherein an article respond button has been pressed to animated the comment cards, wherein FIG. 3a shows the comment cards in an initial configuration, FIG. 3b shows a blank comment card with a textbox input as the front card, and FIG. 3c shows the card group with a submitted comment, in accordance with an exemplary embodiment of the present invention;

FIG. 4a and FIG. 4b are diagrams of an embodiment of the invention featuring a webpage comprising a comments panel with a first region appearing below a second region and with a card group comprising comment cards arranged in cascaded form, wherein an article respond button has been pressed to open a comment entry form, wherein FIG. 4a shows the comment cards in an initial configuration, FIG. 4b shows a blank comment card with a textbox input as the front card, in accordance with an exemplary embodiment of the present invention;

FIG. 5a and FIG. 5b are diagrams of a comments panel 100 with a first region appearing below a second region and with a card group comprising comment cards arranged in cascaded form, wherein a drill link has been pressed to animate the comment cards, wherein FIG. 5a shows the comment cards in an initial configuration and FIG. 5b shows the comment cards in a comment hierarchy configuration, in accordance with an exemplary embodiment of the present invention;

FIG. 6a and FIG. 6b are views of a comments panel with a first region appearing below a second region and with a card group comprising comment cards arranged in cascaded form, wherein an undrill link has been pressed to animate the comment cards, wherein FIG. 6a shows the comment cards in a comment hierarchy configuration and FIG. 6b shows the comment cards in an initial configuration, in accordance with an exemplary embodiment of the present invention;

FIG. 7a and FIG. 7b are diagrams of a comments panel with a first region appearing below a second region and with a card group comprising comment cards arranged in cascaded form, wherein an comment respond link has been pressed to animated the comment cards to enable a reader to respond to a comment, wherein FIG. 7a shows the comment cards in an initial configuration, and FIG. 7b shows a blank comment card with a textbox input as the front card, in accordance with an exemplary embodiment of the present invention;

FIG. 8a and FIG. 8b are diagrams of a comments panel, wherein the card group is arranged in vertical adjacently placed form with a first region appearing to the right of a second region, wherein a drill link has been pressed to animate the comment cards, wherein FIG. 8a shows the comment cards in an initial configuration and FIG. 8b shows the comment cards in a comment hierarchy configuration, in accordance with an exemplary embodiment of the present invention;

FIG. 9a and FIG. 9b are diagrams of a comments panel, wherein the card group is arranged in vertical adjacently placed form with a first region appearing below a second region, wherein a drill link has been pressed to animate the comment cards, wherein FIG. 9a shows the comment cards in an initial configuration and FIG. 9b shows the comment cards in a comment hierarchy configuration, in accordance with an exemplary embodiment of the present invention;

FIG. 10 is a diagram of fields that may be provided within the comments database of FIG. 1, in accordance with an exemplary embodiment of the present invention;

FIG. 11 is a flowchart of an exemplary embodiment showing drilling of comment cards in a method for displaying comments using animation, in accordance with exemplary embodiments of the present invention;

FIG. 12 is a flowchart of an exemplary embodiment showing undrilling of comment cards in a method for displaying comments using animation, in accordance with exemplary embodiments of the present invention;

FIG. 13 is a flowchart of exemplary embodiments for a method for displaying comments using animation, in accordance with exemplary embodiments of the present invention; and

FIG. 14 is a flowchart of an exemplary embodiment showing a method for displaying comment cards, wherein a comment respond link has been pressed, in accordance with exemplary embodiments of the present invention.

### REFERENCE NUMERALS IN THE DRAWINGS

video display interface 10

webpage 20

article 30

comments panel 100

first region 102

second region 104

header region 106

header region text 108

shuffle button 110

side 120

left side 122

right side 124

bottom side 126

top side 128

card group 200

comment card 210

front card 212

back card 214

blank comment card 216

comment 220

textbox input 222

partially visible region 224

parent card 250

parent comment 252

child card 260

child comment 262

abuse flagging button 270

comment respond link 272

marking button 274

article respond button 276

drill link 280

undrill link 290

comment entry form 300

comments database 500

comment identification field 510

post identification field 520

parent identification field 530

comment status field 540

create date field 550

user first name field 560

location field 570

text field 580

### DETAILED DESCRIPTION

Illustrative embodiments of the invention are described below in the accompanying Figures. The following detailed description provides detailed schematics for a thorough understanding of and an enabling description for these embodiments. One having ordinary skill in the art will understand that the invention may be practiced without certain details. In other instances, well-known structures and functions have not been shown or described in detail to avoid unnecessarily obscuring the description of the embodiments.

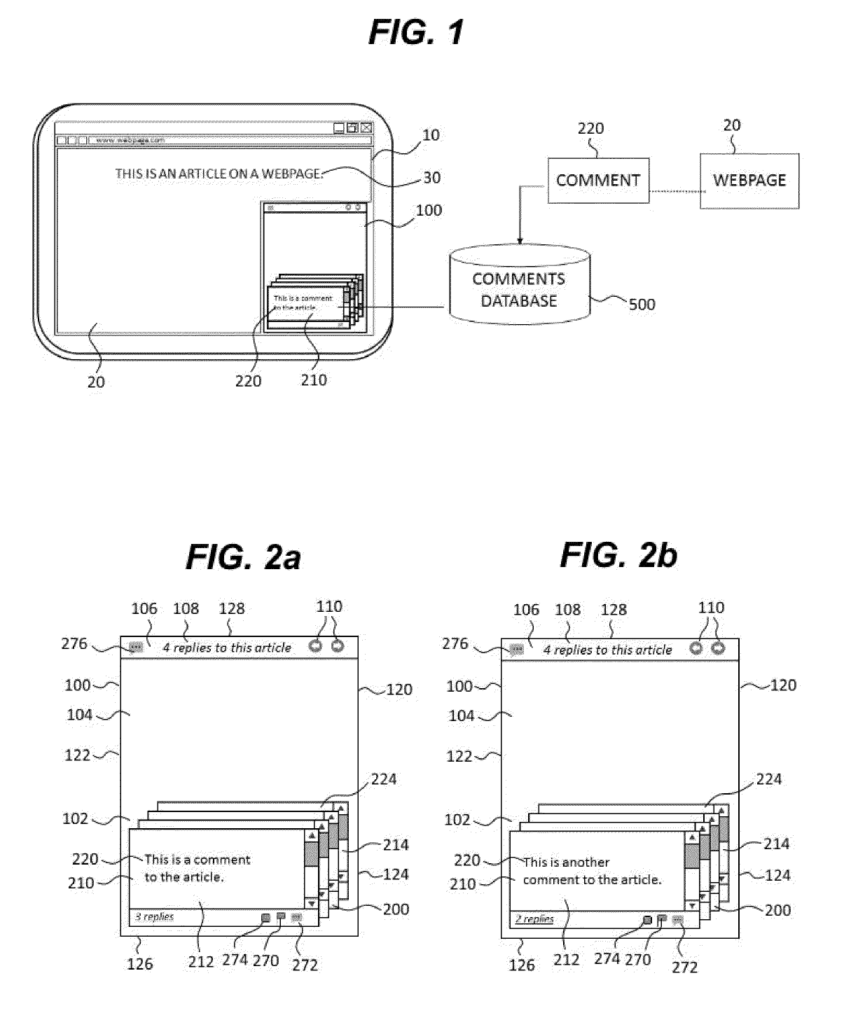

FIG. 1 is a diagram of an example video display interface 10 showing an article 30 and a comments panel 100 on a webpage 20, in accordance with an exemplary embodiment of the present invention. In general, the video display interface 10 may comprise a memory and one or more processors or is in communication with another device that comprises a memory, or memory unit, a screen, and one or more processors. The video display interface 10 may be a computer screen, touch sensitive display, or a portable device and may comprise a keyboard integrated within or connected externally to allow a reader (not shown) to access and view a webpage 20 and respond to the article 30 or to comments 220 on the webpage 20. Comments 220 entered by readers may be stored in a comments database 500 associated with the webpage 20 and retrieved as necessary.

The comments panel 100 may be located anywhere on the video display interface 10, either statically wherein the location of the comments panel 100 is fixed, or dynamically wherein a reader can move the comments panel 100 to a location of his or her choosing. Advertisements may be presented on the article 30, the comments panel 100, or anywhere on the webpage 20.

FIG. 2a and FIG. 2b are diagrams of a comments panel 100 with a first region 102 appearing below a second region 104 and with a card group 200 comprising comment cards 210 arranged in cascaded form, wherein one of two shuffle buttons 110 have been pressed to initiate animation of the comment cards 210, wherein FIG. 2a shows the comment cards 210 in an initial configuration and FIG. 2b shows the comment cards 210 in a shuffled configuration, in accordance with an exemplary embodiment of the present invention. In this example embodiment, the comments panel 100 comprises two shuffle buttons 110, a left side 122, a right side 124, a bottom side 126, a top side 128, a first region 102, a second region 104, a header region 106, and a card group 200 comprising one or more comment cards 210, wherein each comment card 210 displays one comment 220 in response to an article 30 or another comment 220, wherein the header region 106 may comprise header region text 108. The shuffle buttons 110 in this example embodiment are a shuffle left button and a shuffle right button.

The comments panel 100 may comprise one or more sides 120 in the form of a solid, dotted, dashed, or transparent line and may also comprise a background of any color and any extent of transparency, wherein a side 120 may be a left side 122, a right side 124, a bottom side 126, a top side 128, a side to a polygon with greater than four sides, or any combination thereof. Comments 220 described herein may comprise text, one or more images, audio data, video data, or any combination thereof. The first region 102 and second region 104 may be located anywhere on the comments panel 100, and either one of the first region 102 or second region 104 may also comprise an outer perimeter in the form of a solid, dotted, dashed, or transparent line, and may also comprise a background of any color and any extent of transparency.

In the example embodiment in FIG. 2a and FIG. 2b, the comment cards 210 in card group 200 are arranged in cascaded form, similar to a digital deck of cards, wherein a front card 212 appears in front of one or more other comment cards 210 and has a comment 220 visible to the reader, wherein other comment cards 210 in the card group 200 each have a partially visible region 224. Although not necessary for embodiments described herein, comment cards 210 may further comprise an abuse flagging button 270 that enables readers to inform a webpage host of a comment 220 deemed inappropriate by a reader.

In an embodiment, a comment card 210 may further comprise a marking button 274 that enables a reader to mark a particular comment card 210 with text, graphics, or a tab comprising any color of the reader's choosing, thus further enhancing the organization as well as customization of comment cards 210 by a reader.

Shuffle buttons 110 may be pressed by a reader to animate the comment cards 210 within a particular card group 200. In the example embodiment in FIG. 2a and FIG. 2b, one of the shuffle buttons 110 may be pressed by a reader to initiate animation of the back card 214, located at the back of the card group 200, towards the left side 122, right side 124, bottom side 126, or top side 128, then towards the card group 210 to become defined as the front card 212. Likewise, as shown by the example in FIG. 2a and FIG. 2b, a shuffle button 110 may be pressed by a viewer to animate the front card 212 to the left side 122, right side 124, or bottom side 126, then to the back of the card group 200 to become defined as the new back card 214. This example embodiment enables a reader to shuffle through a card group 200 and view a variety of either parent comments 252 or child comments 262 with reduced confusion to the reader.

In an alternative embodiment, a reader may click on a partially visible region 224 of any comment card 210 other than the front card 212 to initiate animation of that particular comment card 210 to become defined as the front card 212.

The comment cards 210 within a card group 200 may be arranged in a number of forms as desired by the programmer of the webpage 20. Such forms include, but are not limited to, cascaded form, wherein a front card of the card group 200 is fully viewable, wherein other comment cards of said card group 200 may comprise a partially viewable region 224.

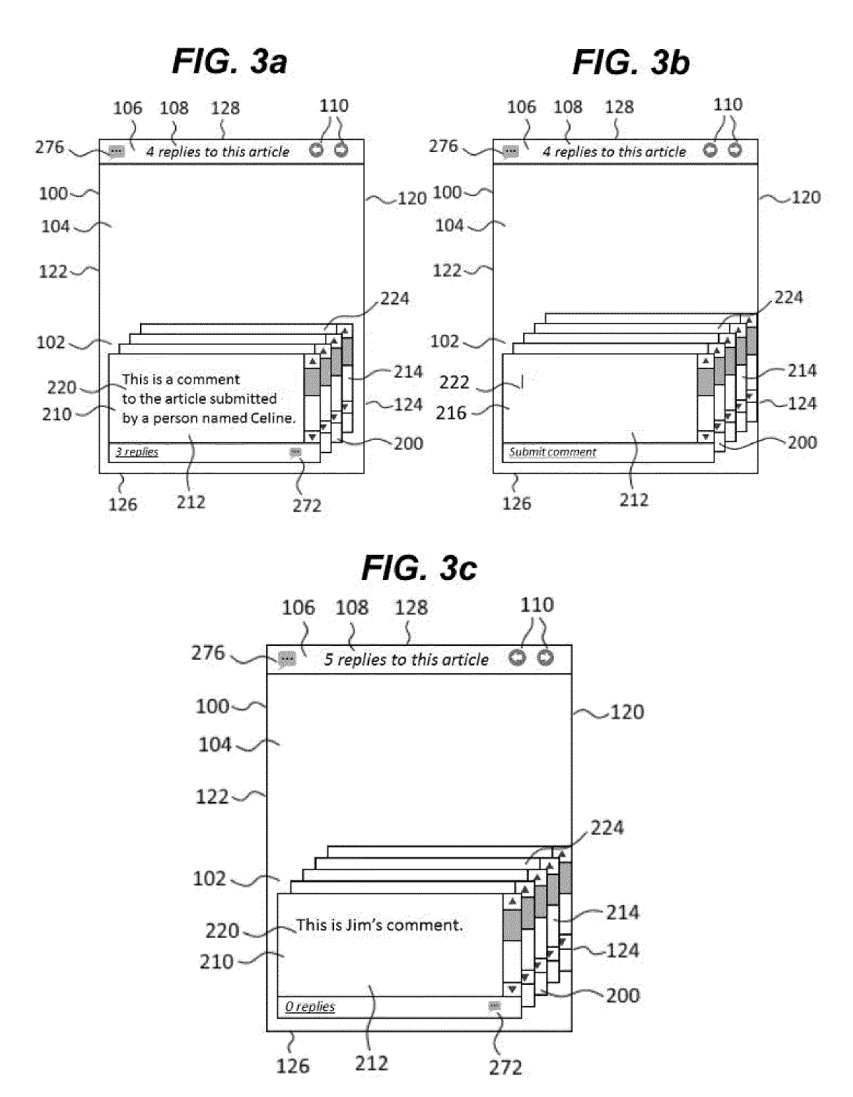

FIG. 3a, FIG. 3b, and FIG. 3c are diagrams of an exemplary embodiment of the invention wherein a user comment can be created, featuring a comments panel 100 with a first region 102 appearing below a second region 104 and with a card group 200 comprising comment cards 210 arranged in cascaded form, wherein an article respond button 276 has been pressed to animated the comment cards 210, wherein FIG. 3a shows the comment cards 210 in an initial configuration, FIG. 3b shows a blank comment card 216 with a textbox input 222 as the front card 212, and FIG. 3c shows the card group 200 with a submitted comment 210, in accordance with an exemplary embodiment of the present invention. In this example embodiment, a reader may respond to the article 30 by pressing article respond button 276, wherein pressing of the article respond button 276 initiates animation of a blank comment card from a non-viewable location towards the front card 212 of said card group 200 to become defined as the front card 212 of the card group 200. A submit link for submitting the comment to the comments database 500 may be pressed to submit the comment 220.

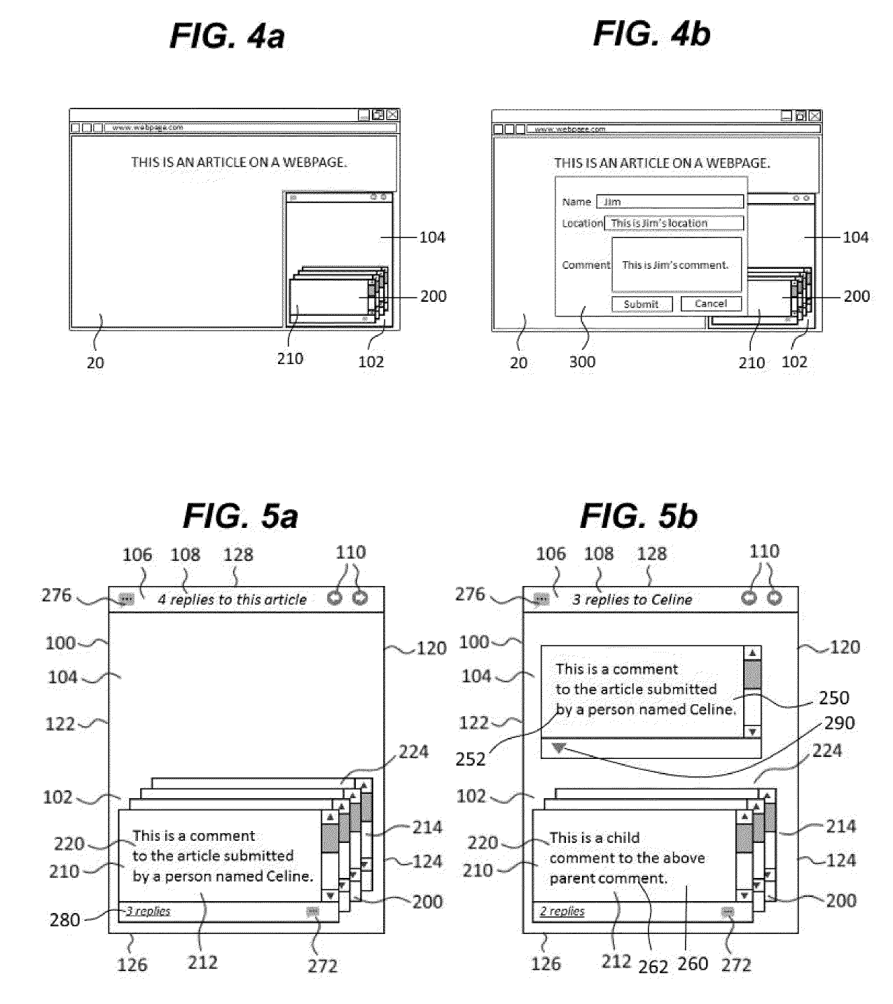

FIG. 4a and FIG. 4b are diagrams of an embodiment of the invention featuring a webpage 20 comprising a comments panel 100 with a first region 102 appearing below a second region 104 and with a card group 200 comprising comment cards 210 arranged in cascaded form, wherein an article respond button 276 has been pressed to open a comment entry form 300, wherein FIG. 4a shows the comment cards 210 in an initial configuration, FIG. 4b shows a blank comment card 216 with a textbook input 222 as the front card 212, in accordance with an exemplary embodiment of the present invention. In this example embodiment, a reader responds to the article 30 by pressing article respond button 276, wherein pressing of article respond button 276 opens up a comment entry form 300, which generally comprises fields or textbox inputs for a reader to submit a comment 220, wherein after submission of the comment 220, the comments panel 100 may take the configuration shown in FIG. 3c.

FIG. 5a and FIG. 5b are diagrams of a comments panel 100 with a first region 102 appearing below a second region 104 and with a card group 200 comprising comment cards 210 arranged in cascaded form, wherein a drill link 280 has been pressed to animate the comment cards 210, wherein FIG. 5a shows the comment cards 210 in an initial configuration and FIG. 5b shows the comment cards 210 in a comment hierarchy configuration, in accordance with an exemplary embodiment of the present invention. The comment cards 210 within a card group 200 may be either parent cards 250 in entirety or child cards 260 in entirety; however, a card group 200 does not comprise both parent cards 250 and corresponding child cards 260 within the same card group 200. The parent cards 250 and child cards 260 comprise parent comments 252 and child comments 262, respectively. When a reader responds to a comment 220, the comment 220 of the reader is defined as a child comment 262, and the comment 220 to which the child comment 262 is responding is the parent comment 252.

If a reader responds to a parent comment 252, then the parent card 250 comprising said parent comment 252 further comprises a drill link 280 to indicate to a reader that the parent comment 252 has one or more corresponding child comments 262, wherein the drill link may read a number of child comments 262 to said parent comment 252. Numerous forms of drill links 280 may be implemented without deviating from the scope of the present invention. Drill links 280 may be blue-underlined and may state the number of replies to a particular comment. For example, a drill link 280 of a parent card 250 may read as “3 replies”, indicating to a reader that the parent comment 252 of that particular parent card 250 has three corresponding child comments 262 that have been made in response to the parent comment 252. When a reader clicks a drill link 280 of a parent card 250, the drill link 280 is removed from view, and the parent card 250 animates from the first region 102 towards the second region 104 and is displayed without any other comment cards 210 being located in the second region 104. Upon animation of the parent card 222 towards the second region 104, a new card group 200 comprising one or more child cards 260 animates from the left side 122, right side 124, or bottom side 126 to the first region 104, thus the comments panel 100 assumes the configuration in the example in FIG. 3b. This process indicates clearly to a reader that the parent card 250 located in the second region 104 comprises the parent comment 252 to which child cards 260 located in the first region 102 correspond to and have child comments 262 in response to. The card group 210 in the first region 102 may now be shuffled by a reader by pressing a shuffle button 110 or pressing a partially visible region 224, as previously described.

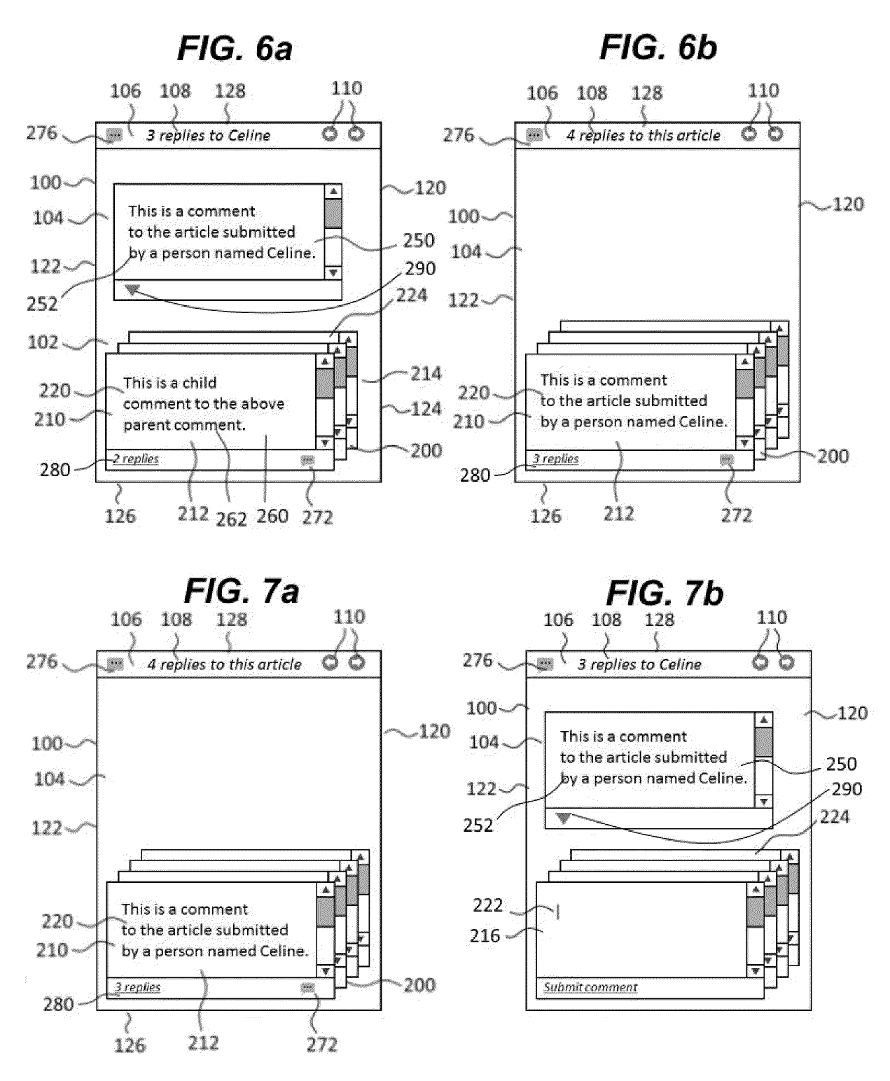

FIG. 6a and FIG. 6b are views of a comments panel 100 with a first region 102 appearing below a second region 104 and with a card group 200 comprising comment cards 210 arranged in cascaded form, wherein an undrill link 290 has been pressed to animate the comment cards 210, wherein FIG. 6a shows the comment cards 210 in a comment hierarchy configuration and FIG. 6b shows the comment cards 210 in an initial configuration, in accordance with an exemplary embodiment of the present invention. The undrill link 290 may be located anywhere on a parent card 250 but is generally located in a region absent of a parent comment 252, and is more generally located in the region previously comprising the drill link 280. When a reader clicks the undrill link 290, the parent card 252 animates towards the first region 102 and joins with the card group 200 comprising other parent cards 250 that respond to the same article 30 or comment 220. Simultaneously, the card group 210 in the first region 102 animates towards the left side 122, the right side 124, or the bottom side 126 and out of view of the reader.

FIG. 7a and FIG. 7b are diagrams of a comments panel 100 with a first region 102 appearing below a second region 104 and with a card group 200 comprising comment cards 210 arranged in cascaded form, wherein an comment respond link 272 has been pressed to animated the comment cards 210 to enable a reader to respond to a comment 220, wherein FIG. 7a shows the comment cards 210 in an initial configuration, and FIG. 7b shows a blank comment card 216 with a textbox input 222 as the front card 212, in accordance with an exemplary embodiment of the present invention. Pressing of the comment respond link 272 initiates animation of the comment card 210 from the first region 102 to the second region 104, wherein a blank comment card 216 become visible to a reader in the first region 102 and comprises a textbox input 222 for a reader to enter a new comment 220 that will become defined as a child comment 262 to the comment 210 of the comment card 210 wherein the comment respond link 272 on was pressed, the comment 210 becoming defined as the parent comment 252 to the child comment 262.

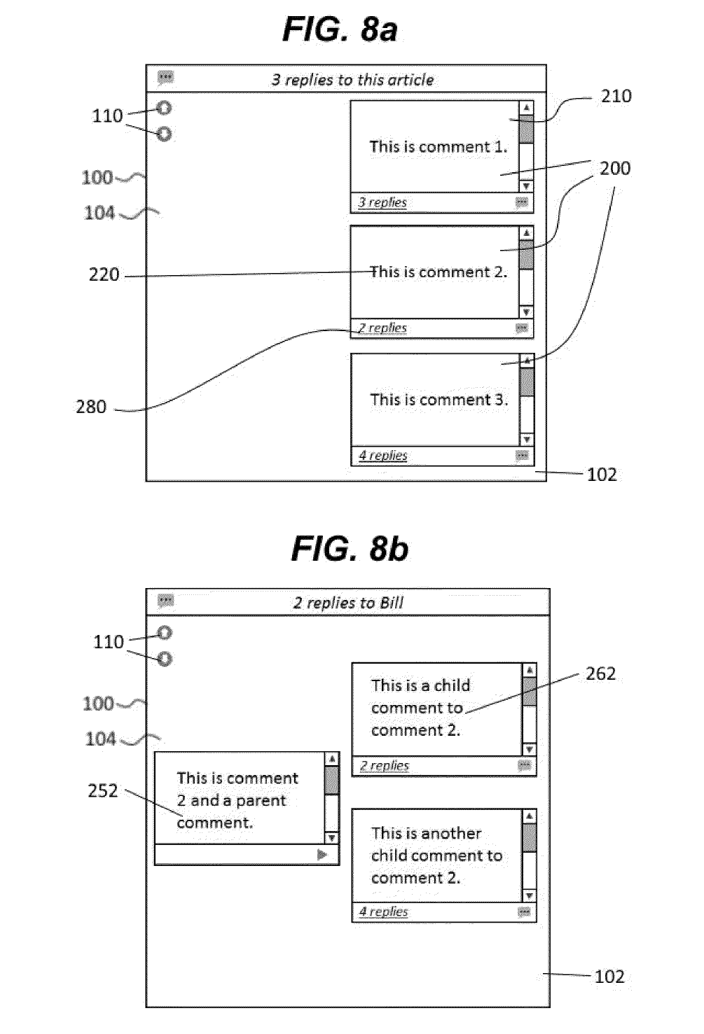

FIG. 8a and FIG. 8b are diagrams of a comments panel 100, wherein the card group 200 is arranged in vertical adjacently placed form with a first region 102 appearing to the right of a second region 104, wherein a drill link 280 has been pressed to animate the comment cards 210, wherein FIG. 8a shows the comment cards 210 in an initial configuration and FIG. 8b shows the comment cards 210 in a comment hierarchy configuration, in accordance with an exemplary embodiment of the present invention. This example embodiment demonstrates how comment cards 210 may be arranged for viewing multiple comments 220 at any given time.

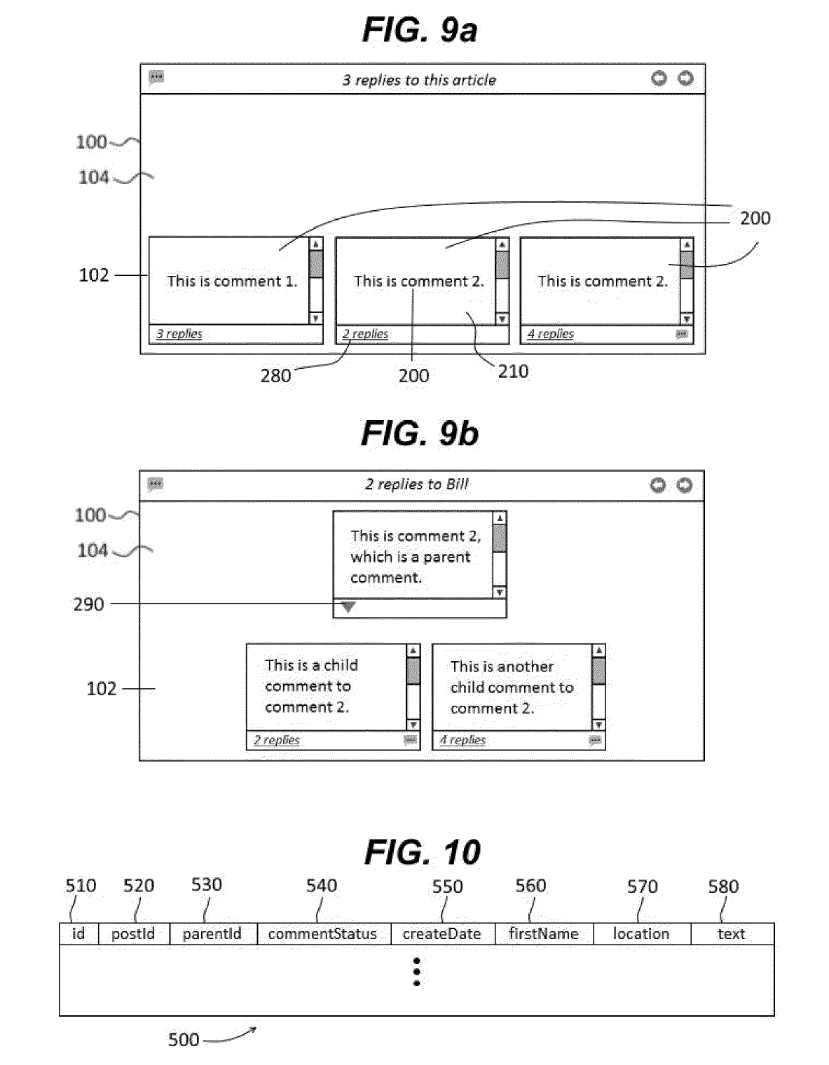

FIG. 9a and FIG. 9b are diagrams of a comments panel 100, wherein the card group 200 is arranged in vertical adjacently placed form with a first region 102 appearing below a second region 104, wherein a drill link 280 has been pressed to animate the comment cards 210, wherein FIG. 9a shows the comment cards 210 in an initial configuration and FIG. 9b shows the comment cards 210 in a comment hierarchy configuration, in accordance with an exemplary embodiment of the present invention. This example embodiment also demonstrates how comment cards 210 may be arranged for viewing multiple comments 220 at any given time.

FIG. 10 is a diagram of fields that may be provided within the comments database 500 of FIG. 1, in accordance with an exemplary embodiment of the present invention. The comments database 500 may include a comment identification field 510, a post identification field 520, a parent identification field 530, a comment status field 540, a create date field 550, a user first name field 560, a location field 570, and a text field 580. In other embodiments, the comments database 500 may include more or fewer fields.

The comment identification field 510 may store information that uniquely identifies a particular comment 220. The post identification field 520 may store information that identifies the associated article 30 with the comment 220. The parent identification field 530 may store information that identifies the parent comment 252 associated with the particular comment 220 and generally takes the form of a null value if the comment 220 is in response to an article 30 and not in response to another comment 220.

A comment status field 540 may store information corresponding to if and when a comment 220 may be published. For example, the comment status field 540 may store values such as “approved”, “rejected”, or “published” to denote that a particular comment 220 has, respectively, been approved for publication, rejected for publication, or has already been published.

A create date field 550 may store information about the date in which a particular comment 220 has been created. A user first name field 560 and location field 570 may store information about the name and location of the reader submitting a comment 220, respectively. A text field 580 may store information about the textual content of a comment 220.

Additional fields may include more information about comment 220, article 30, or the reader submitting a comment 220. Examples of additional fields may include, but are not limited to, fields that may store information about other identification accounts of the reader submitting a comment 220, such as Facebook, Twitter, LinkedIn, or Disqus, fields that may store information about an avatar image, or reference to it, fields that may store information about a reader's local account, such as password or profile information, or fields that may store information about ratings, such as number of likes or number of dislikes as related to the comment.

The comments database 500 may also include fields that may store information about the maximum number of allowable child card 260 levels within a string of parent cards 250 and child cards 260, if a maximum exists. Additionally, the comments database 500 may include fields that store information about the total number of comments 220 that will be published.

Any of the methods described herein may further comprise the step of accessing a comments database 500 to display one or more relevant comments 220 on said comments card 210.

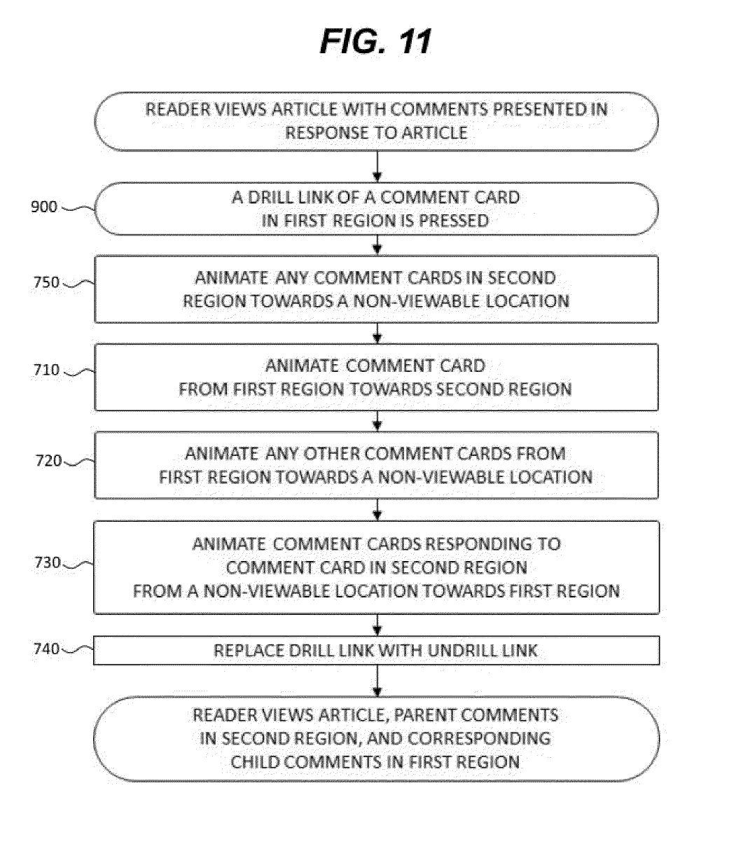

FIG. 11 is a flowchart of an exemplary embodiment showing drilling of comment cards 210 in a method for displaying comments 220 using animation, in accordance with exemplary embodiments of the present invention. The method generally comprises the steps of displaying one or more comment cards 210 in a card group 200 located on a first region 102 of a comments panel 100, wherein the comment card 210 comprises a drill link 280 and a comment 220 in response to an article 30 or a parent comment 252, wherein the comments panel 100 further comprises a second region 104, and, in response to a first single action being performed (block 900), animating the comment card 210 from the first region 102 towards the second region 104 (block 710), wherein the comment card 210 becomes defined as a parent card 250 and comprises a parent comment 252, animating any other comment cards 210 in the card group 200 from the first region 102 towards a non-viewable location (block 720), animating one or more child cards 260 from a non-viewable location towards the first region 102 (block 730), wherein each of the child cards 260 comprise a child comment 262 in response to the parent comment 252, and replacing the drill link 280 with an undrill link 290 (block 740). The first single action being performed may be the pressing of a drill link 280 located on a comment card 210.

The method may further comprise the step of animating the comment cards 210 from the second region 104 towards a non-viewable location (block 750). This step if generally performed to clear the second region 104 of a parent card 250 when a child card 260 corresponding to that parent card 250 is itself in response to a first single action being performed.

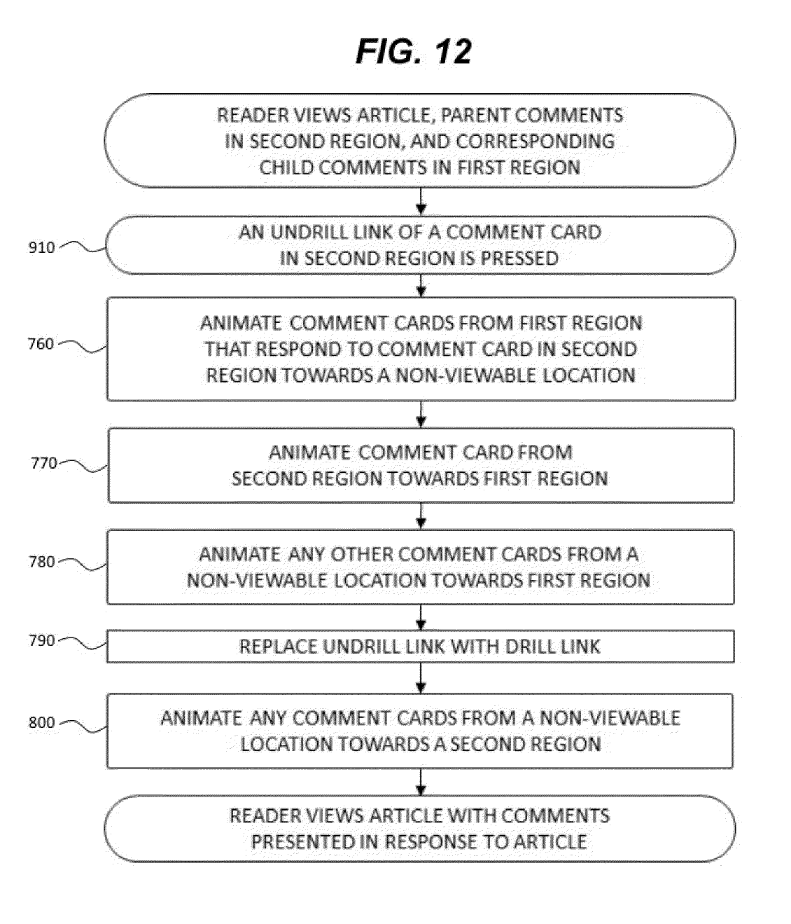

FIG. 12 is a flowchart of exemplary embodiments showing undrilling of comment cards 210 in a method for displaying comments 220 using animation, in accordance with exemplary embodiments of the present invention. In this embodiment, the method may further comprise the step of, in response to a second single action being performed (block 910), animating one or more child cards 260 from the first region 102 towards a non-viewable location (block 760), animating the comment card 210 from the second region 104 towards the first region 102 (block 770), animating any other comment cards 210 in the card group 200 from a non-viewable location towards the first region 102 (block 780), and replacing the undrill link 290 with said drill link 280 (block 790). The second single action being performed may be the pressing of an undrill link 290 located on a comment card 210.

The method may further comprise the step of animating any comment cards 210 from a non-viewable location towards the second region 104 (block 800), wherein the comment cards 210 are parent cards 250 to a child card 260 wherein a second single action has been performed. This step is generally performed when a plurality of drilling steps have taken place previously.

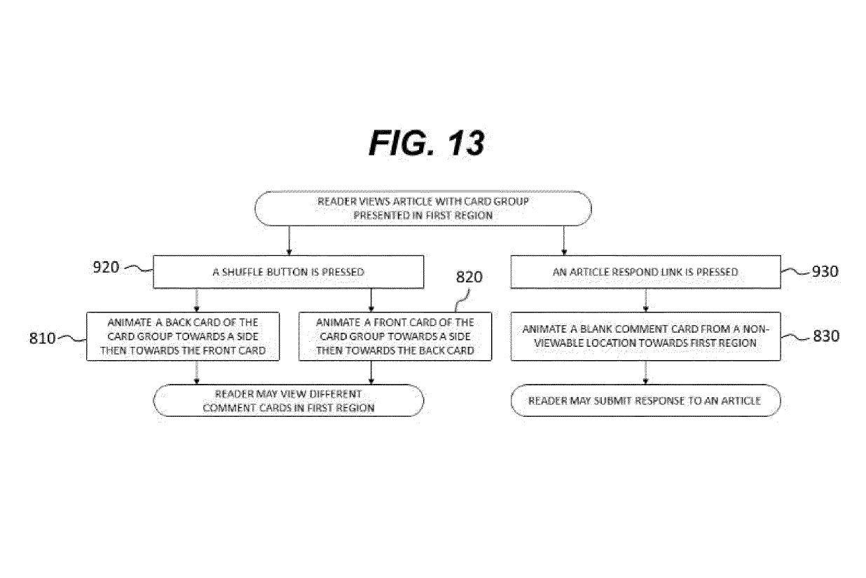

FIG. 13 is a flowchart of an exemplary embodiment for a method for displaying comments 220 using animation, in accordance with exemplary embodiments of the present invention. The method may further comprise the step of pressing on a shuffle button 110 located on the comments panel 100 (block 920), wherein pressing of the shuffle button 110 initiates animating a back card 214 of the card group 200 towards at least one of the sides 120 then towards the front card 212 of the card group 200 to become defined as the front card 212 of the card group 200 (block 810). The method may further comprise the step of pressing on a shuffle button 110 located on the comments panel 100 (block 920), wherein pressing of the shuffle button 110 initiates animating of the front card 212 to at least one of the sides 120 then towards a back card 214 of the card group 200 to become defined as the back card 214 of the card group 200 (block 820). The method may further comprise the step of pressing on an article respond button 276 located on the comments panel 100 (block 930), wherein pressing of the article respond button 276 initiates animating of a blank comment card 216 from a non-viewable location towards the first region 102 (block 830), and, in a case where the card group 200 is arranged as cascaded, towards the front card 212 of the card group 200 to become defined as the front card 212 of the card group 200. This step may be accompanied by a step of replacing the drill link 280 with a submit comment link.

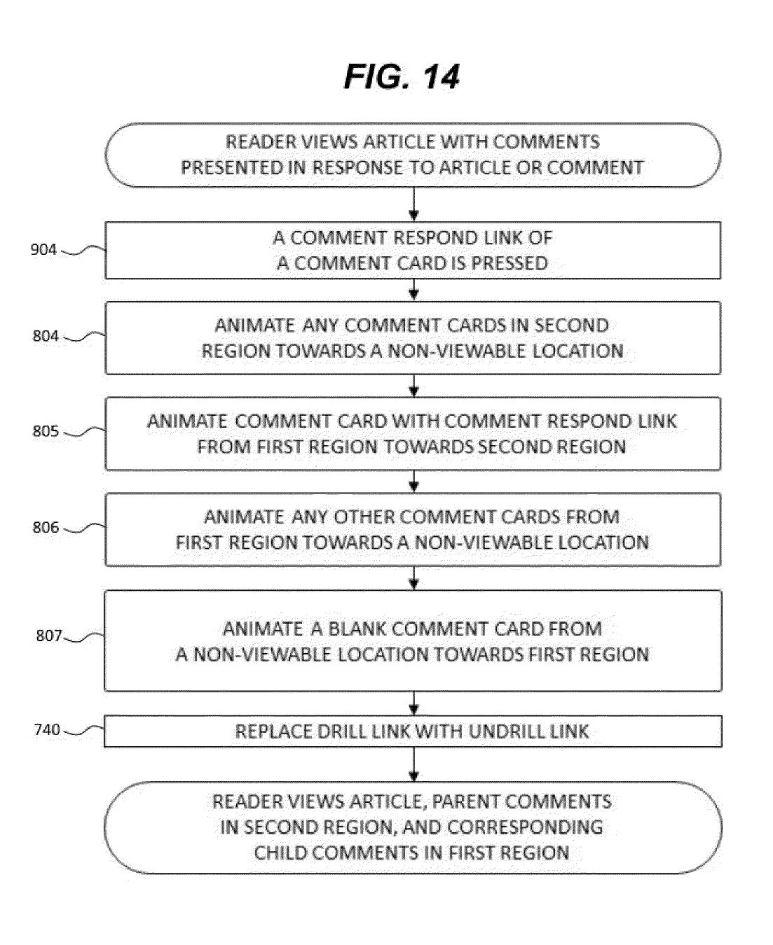

FIG. 14 is a flowchart showing a method for displaying comment cards 210, wherein a comment respond link 272 has been pressed, in accordance with exemplary embodiments of the present invention. The method may further comprise the step of pressing on a comment respond link 272 located on one or more of the comment cards 210, wherein pressing of the comment respond link 272 (block 940) initiates animating the comment card 210 from the first region 102 towards the second region 104 (block 840), wherein the comment card 210 becomes defined as a parent card 250 and comprises a parent comment 252, animating one or more child cards 260 from a second non-viewable location towards the first region 102 (block 850), wherein each of the child cards 260 comprise a child comment 262 in response to said parent comment 252, animating any other comment cards 210 in the card group 200 from the first region 102 towards a first non-viewable location (block 860), animating of a blank comment card 216 from a non-viewable location towards the front card 212 of the card group 200 to become defined as the front card 212 of the card group 200 (block 870). This step may be accompanied by a step of replacing the drill link 280 with a submit comment link.

Using input data collected from commenters and readers of the present system and method, the inventor anticipates integrating and delivering specific and/or custom online advertisements onto a webpage containing the present using the same methods of delivery as described herein for text and/or web commentary.

In embodiments described herein, a non-viewable location generally refers to a location where the comment card 210 is out of view from a reader, and may be towards a side 120 or into a background.

In embodiments described herein, the color of any link or button, including the drill link 280, may be blue, green, red, brown, black, and orange, or any combination thereof, and the form of any link or button, including the drill link 280, may be standard, bolded, underlined, italicized, static graphic, animated graphic, or any combination thereof.

While the above described embodiments of the invention is applied directly to internet webpages having sections for readers to post comments in response to an article or parent comment, the embodiments may also be applied to other types of telecommunication, which include, but are not limited to, cell phone texting messages, chat room applications, etc.

While particular embodiments of the invention have been described and disclosed in the present application, it is clear that any number of permutations, modifications, or embodiments may be made without departing from the spirit and the scope of this invention. Accordingly, it is not the inventor's intention to limit this invention in this application, except as by the claims.

Particular terminology used when describing certain features or aspects of the invention should not be taken to imply that the terminology is being redefined herein to be restricted to any specific characteristics, features, or aspects of the invention with which that terminology is associated. In general, the terms used in the claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise embodiment or form disclosed herein or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

In general, the terms used in the claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

In light of the above “Detailed Description,” Inventor may make changes to the invention. While the detailed description outlines possible embodiments of the invention and discloses the best mode contemplated, no matter how detailed the above appears in text, the invention may be practiced in a myriad of ways. Thus, implementation details may vary considerably while still being encompassed by the spirit of the invention as disclosed by the inventor. As discussed herein, specific terminology used when describing certain features or aspects of the invention should not be taken to imply that the terminology is being redefined herein to be restricted to any specific characteristics, features, or aspects of the invention with which that terminology is associated.

I claim:

1. A system for displaying comments, comprising:
a memory;
one or more processors; and
a video display interface, wherein said video display interface displays:
a comments panel comprising a first region, a second region, at least one side, and a card group comprising one or more comment cards, wherein each of said comment cards comprises a comment and a drill link, wherein said comment is in response to an article or a parent card, wherein pressing of said drill link initiates animation of said comment card from said first region toward said second region and initiates animation of one or more child cards from a side of said comments panel towards said first region, wherein each of said child cards comprises a child comment in response to said parent comment on said parent card, wherein pressing of said drill link replaces said drill link with an undrill link, wherein pressing of said undrill link initiates animation of said card group located in said first region towards a side of said comments panel and initiates animation of said parent card from said second region to said first region.

2. The system of claim 1, wherein said comment cards of said card group are arranged in cascaded form, wherein a front card of said card group is fully viewable, wherein other comment cards of said card group are partially viewable.

3. The system of claim 2, wherein said comments panel further comprises one or more shuffle buttons, wherein pressing of said shuffle button initiates animation to rearrange said card group located in said first region, wherein rearrangement results in one of said comment cards of said card group to become defined as a new front card.

4. The system of claim 2, wherein pressing of one of said comment cards in said first region initiates animation of said one said comment card to become defined as a new front card.

5. The system of claim 1, wherein said comments panel further comprises a header region, wherein said header region comprises said one or more shuffle buttons, said drill link, or said undrill link.

6. The system of claim 3, wherein pressing of said shuffle button initiates animation of a back card of said card group towards a side of said comments panel then towards said front card to become defined as a new front card.

7. The system of claim 3, wherein pressing of said shuffle button initiates animation of said front card towards a side of said comments panel then towards said back card of said card group to become defined as said back card.

8. The system of claim 1, wherein said drill link reads a number of child comments to said parent comment.

9. The system of claim 1, wherein said drill link comprises a drill link color and a drill link form, wherein said drill link color is selected from the group consisting of blue, green, red, brown, black, orange and combinations thereof, wherein said drill link form is selected from the group consisting of standard, bolded, underlined, italicized, static graphic, animated graphic, and combinations thereof.

10. The system of claim 1, wherein at least one of said comment cards further comprise an abuse flagging button.

11. The system of claim 1, wherein at least one of said comment cards further comprise a respond link, wherein pressing of said respond link initiates animation of said one comment card from said first region towards said second region, wherein a blank comment card animates from a side towards said first region or otherwise becomes viewable in said first region, wherein said black comment card comprises a textbox input.

12. The system of claim 1, wherein at least one of said comment cards further comprise a marking button, wherein pressing of said marking button allows said comment card to be annotated with text or a tab.

13. The system of claim 1, wherein said video display interface is a touch sensitive display.

14. The system of claim 1, wherein said comments panel is statically located on said video display interface.

15. The system of claim 1, wherein said comments panel is dynamically located on said video display interface, wherein a reader can move said comments panel to a desired location.

16. A method for displaying comments, comprising the steps of:
displaying one or more comment cards in a card group located on a first region of a comments panel, wherein said comment card comprises a drill link and a comment in response to an article or a parent comment, wherein said comments panel further comprises a second region; and
in response to a first single action being performed:
animating said comment card from said first region towards said second region, wherein said comment card becomes defined as a parent card and comprises a parent comment;
animating any other comment cards in said card group from said first region towards a side or into a background;
animating one or more child cards from a side or into a background towards said first region, wherein each of said child cards comprise a child comment in response to said parent comment; and
replacing said drill link with an undrill link.

17. The method of claim 16, wherein said first single action being performed is pressing on a drill link.

18. The method of claim 16, further comprising the step of:
animating said comment cards from said second region towards a side or into a background.

19. The method of claim 16, further comprising the step of:
in response to a second single action being performed:
animating said one or more child cards from said first region towards a side or into a background;
animating said comment card from said second region towards said first region;
animating any other comment cards in said card group from a fifth non-viewable location towards said first region; and
replacing said undrill link with said drill link.

20. The method of claim 19, wherein said second single action being performed is pressing on an undrill link.

21. The method of claim 16, wherein said comment cards of said card group are arranged in cascaded form, wherein a front card of said card group is fully viewable, wherein other comment cards of said card group are partially viewable.

22. The method of claim 21, further comprising the step of:
pressing on a shuffle button located on said comments panel, wherein pressing of said shuffle button initiates:
animating a back card of said card group towards at least one of said sides then towards said front card of said card group to become defined as said front card of said card group.

23. The method of claim 21, further comprising the step of:
pressing on a shuffle button located on said comments panel, wherein pressing of said shuffle button initiates:
animating of said front card to at least one of said sides then towards a back card of said card group to become defined as said back card of said card group.

24. The method of claim 16, further comprising the step of:
pressing on an article respond button located on said comments panel, wherein pressing of said article respond button initiates:
animating of a blank comment card from a side or into a background towards said front card of said card group to become defined as said front card of said card group.

25. The method of claim 16, further comprising the step of:
pressing on a comment respond link located on one or more of said comment cards, wherein pressing of said comment respond link initiates:
animating said comment card from said first region towards said second region, wherein said comment card becomes defined as a parent card and comprises a parent comment;
animating one or more child cards from a second non-viewable location towards said first region, wherein each of said child cards comprise a child comment in response to said parent comment;
animating any other comment cards in said card group from said first region towards a first non-viewable location;
animating of a blank comment card from a side or into a background towards said front card of said card group to become defined as said front card of said card group.

26. The method of claim 21, further comprising the step of:
pressing on a shuffle button located on said comments panel, wherein pressing of said shuffle button initiates animation of said front card to at least one of said sides then towards a back card of said card group to become defined as said back card of said card group.

27. A computer program product for displaying comments on a webpage that, when executed, initiates animation of said comments.

28. The method of claim 16, further comprising the step of:
accessing a comments database to display one or more relevant comments on said comments card.
